(19) United States
(12) Patent Application Publication
(10) Pub. No.: US 2010/0299275 A1
(43) Pub. Date: Nov. 25, 2010

(54) CONTENT-BASED SOCIAL COMPUTING

(75) Inventor: Steven Greenspan, Scotch Plains, NJ (US)

Correspondence Address: SCHWEGMAN, LUNDBERG & WOESSNER, P.A., P.O. BOX 2938, MINNEAPOLIS, MN, 55402, US

(73) Assignee: Computer Associates Think, Inc., Islandia, NY (US)

(21) Appl. No.: 12/470,023

(22) Filed: May 21, 2009

(51) Int. Cl. G06Q 99/00; G06F 17/30

(52) U.S. Cl. 705/319; 707/E17.108; 707/E17.044

(57) ABSTRACT

A system and method for social computing distribute a message from an author to one or more subscribers as a function of the content of the message. In an embodiment, the content of a message is related to a meta-tag. In another embodiment, the author of a message is associated with a group of people which are of interest to the subscribers. In another embodiment, the transmitted messages can be based on the subject matter of content that is associated with a subscriber.

### TECHNICAL FIELD

The present invention relates to social computing systems and methods, and in an embodiment, but not by way of limitation, a social computing system and method that operates as a function of the content of messages and not the author of messages.

### BACKGROUND

Social networking services, such as Twitter, allow users to publish short messages referred to as “tweets” that are immediately distributed to subscribers who wish to read messages from a particular person. This can be referred to as sender-based routing since the routing is based on the identity of the person who publishes the message.

### BRIEF DESCRIPTION OF THE DRAWINGS

FIG. 1 is a flowchart of an example embodiment of a process to distribute a message from an author to a plurality of subscribers as a function of the content of the message.

FIG. 2 is a flowchart of another example embodiment of a process, using a meta tag, to distribute a message from an author to a plurality of subscribers as a function of the content of the message.

FIG. 3 is a flowchart of another example embodiment of a process, using an identification of a group, to distribute a message from an author to a plurality of subscribers as a function of the content of the message.

FIG. 4 is a flowchart of another example embodiment of a process, using a message of a subscriber, to distribute a message from an author to the subscriber as a function of the content of the message.

FIG. 5A is an example of a database of keywords.

FIG. 5B is an example of an electronic message containing keywords.

FIG. 5C is an example of a database of users and their associated keywords.

FIG. 6A is an example of a database of keywords and meta-tags.

FIG. 6B is an example of an electronic message containing keywords and meta-tags.

FIG. 6C is an example of a database of users and their associated keywords and meta-tags.

FIG. 7 is a block diagram of a computer system that can be used in connection with the present disclosure.

### SUMMARY

A system and method for social computing distribute a message from an author to one or more subscribers as a function of the content of the message. In an embodiment, the content of a message is related to a meta-tag. In another embodiment, the author of a message is associated with a group of people which are of interest to the subscribers. In another embodiment, the transmitted messages can be based on the subject matter of content that is associated with a subscriber.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an embodiment, a machine-readable medium includes volatile and/or non-volatile media (e.g., read only memory (ROM), random access memory (RAM), magnetic disk storage media, optical storage media, flash memory devices, etc.).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include digital/analog signal processing systems, software, data processing hardware, data processing system-implemented methods, and various processing operations, further described herein.

A number of figures show block diagrams of systems and apparatus of embodiments of the invention. A number of figures show flow diagrams illustrating systems and apparatus for such embodiments. The operations of the flow diagrams will be described with references to the systems/apparatuses shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

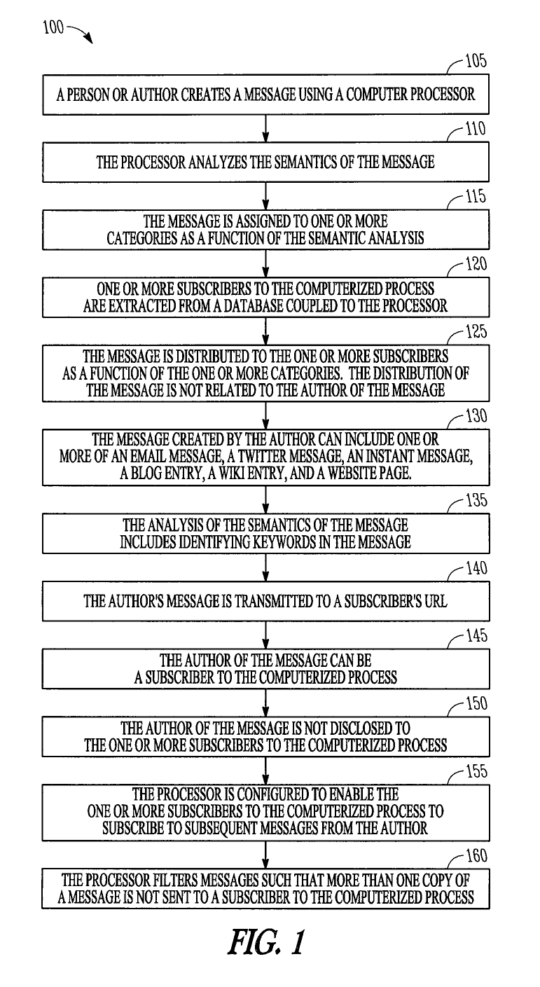

FIGS. 1-4 are flowcharts of example processes 100, 200, 300, and 400 for distributing a message from an author to one or more subscribers as a function of the content of the message. FIGS. 1-4 include a number of process blocks identified by unique numbers. Though arranged serially in the examples of FIGS. 1-4, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

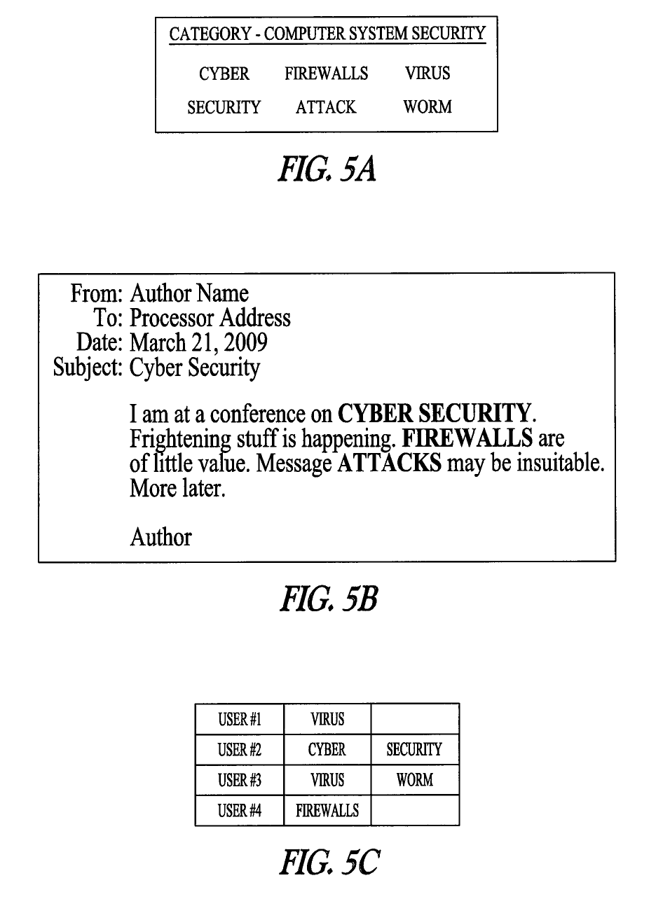

FIG. 1 illustrates an example embodiment of a computerized process 100 to distribute a message from an author to a plurality of subscribers as a function of the content of the message. In this disclosure, a message is an electronic message created by a person for the purposes of contemporaneously transmitting it to a plurality of people based on the content of the message and not on the identity of the author. Such a message is not an article or other prior publication. This can be referred to, in a broad sense, as content-based routing, and can further be described as a system in which receivers of messages subscribe to information categories of interest, and creators of information send content without specifying addresses. The word “author” is used in the most general sense for anyone who creates a message. At 105, a person or author creates a message using a computer processor. At 110, the processor analyzes the message. At 115, the message is assigned to one or more categories as a function of the analysis. At 120, one or more subscribers to the computerized process are extracted from a database coupled to the processor. These subscribers are extracted or chosen because the subscribers are associated with the one or more categories to which the message is assigned. In an embodiment, the one or more subscribers are not identified in the message created by the author. At 125, the message is distributed to the one or more subscribers as a function of the one or more categories. The distribution of the message is not related to the author of the message. The computer processor system that is used to implement the process 100 can be one like that illustrated in FIG. 5, and more than one processor can be involved in a multi-server system, a client-server system, or other types of hardware and system arrangements.

As noted at 130 in FIG. 1, the message created by the author can include one or more of an email message, a twitter message, an instant message, a blog entry, a wiki entry, a website page, or other similar communication. As noted above, such messages are for contemporaneous transmittal. At 135, the analysis of the message includes identifying keywords in the message. The keywords can then be used to identify which category to assign the message. At 140, the author's message is transmitted to a subscriber's URL. A subscriber's URL can be associated with one or more of a hand held device, a website, a blog, a wiki, an email address, or other hardware or logical location. The author of the message can be a subscriber to the computerized process also, as noted at 145. At 150, it is noted that the author of the message is not disclosed to the one or more subscribers to the computerized process. At 155, the processor is configured to enable the one or more subscribers to the computerized process to subscribe to subsequent messages from the author. At 160, the processor filters messages such that more than one copy of a message is not sent to a subscriber to the computerized process.

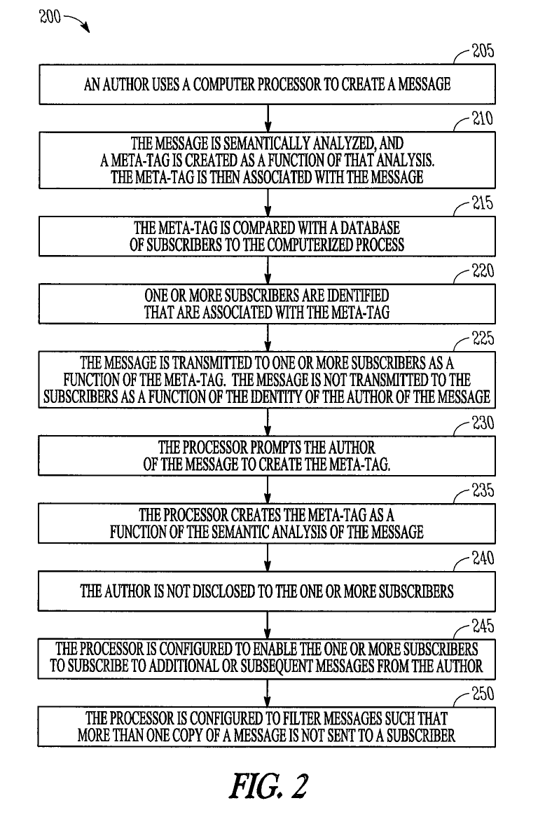

FIG. 2 illustrates another example embodiment of a computerized process 200 to distribute a message from an author to a plurality of subscribers as a function of the content of the message. Referring to FIG. 2, at 205, an author uses a computer processor to create a message. At 210, the message is analyzed, and a meta-tag is created as a function of that analysis. In another embodiment, the author can simply append metadata to the message. As known to one of skill in the art, a meta tag can be an HTML or XHTML element that is used to provide structured metadata about a web page. Such elements are placed as tags in the header section of an HTML or XHTML document. Meta elements can be used to specify page description, keywords, and any other metadata not provided through the other header elements and attributes. The meta-tag is then associated with the message. At 215, the meta-tag is compared with a database of subscribers to the computerized process. At 220, one or more subscribers are identified that are associated with the meta-tag. At 225, the message is transmitted to one or more subscribers as a function of the meta-tag. The message is not transmitted to the subscribers as a function of the identity of the author of the message. Therefore, two different authors can create two different messages, but the two different messages can be assigned a same meta tag, and the two messages will be delivered to subscribers who are associated with that meta tag. In an embodiment, as illustrated at 230, the processor prompts the author of the message to create the meta-tag. At 235, the processor creates the meta-tag as a function of the analysis of the message. In another embodiment, as illustrated at 240, the author is not disclosed to the one or more subscribers. At 245, the processor is configured to enable the one or more subscribers to subscribe to additional or subsequent messages from the author, and at 250, the processor is configured to filter messages such that more than one copy of a message is not sent to a subscriber.

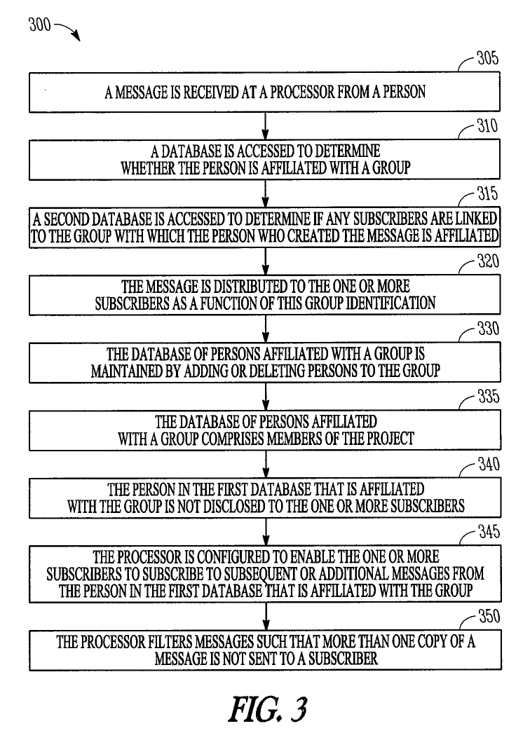

FIG. 3 illustrates another example embodiment of a computerized process 300 to distribute a message from an author to a plurality of subscribers as a function of the content of the message. In the process 300, at 305, a message from a person is received at a processor. At 310, a database is accessed to determine whether the person is affiliated with a group. At 315, a second database is accessed to determine if any subscribers are linked to the group with which the person who created the message is affiliated. That the person who created the message is affiliated with a particular group could be of interest to others such as the subscribers in the second database. For example, the person who created the message may be a project leader, and members (subscribers) of that particular project may be interested in such a message. At 320, the message is distributed to the one or more subscribers as a function of this group identification.

In another embodiment of the process 300, the database of persons affiliated with a group is maintained by adding or deleting persons to the group at 330. At 335, and as noted above, the database of persons affiliated with a group comprises members of a project. For example, the project could be a particular project at a place of business, and the subscribers to the computerized process could have some interest or involvement with the project. At 340, the person in the first database that is affiliated with the group is not disclosed to the one or more subscribers. At 345, the processor is configured to enable the one or more subscribers to subscribe to subsequent or additional messages from the person in the first database that is affiliated with the group. At 350, the processor filters messages such that more than one copy of a message is not sent to a subscriber.

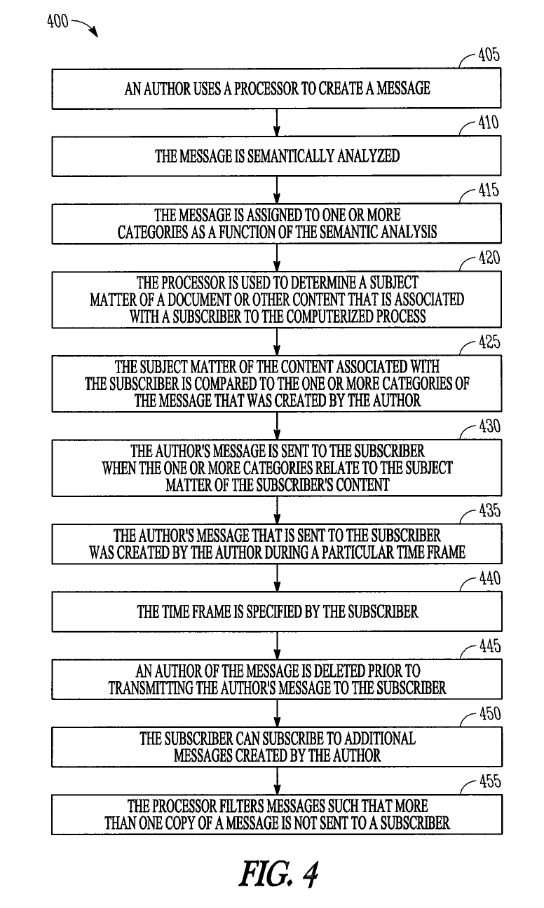

FIG. 4 illustrates another example embodiment of a computerized process 400 to distribute a message from an author to a subscriber as a function of the content of the message. Referring to FIG. 4, at 405, an author uses a processor to create a message. At 410, the message is analyzed. At 415, the message is assigned to one or more categories as a function of the analysis. At 420, the processor is used to determine a subject matter of a document or other content that is associated with a subscriber to the computerized process. This content associated with a subscriber could be an open email message from the subscriber's inbox, an unopened message from the subscriber's inbox, or any other document or other content that is somehow associated with the subscriber. At 425, the subject matter of the content associated with the subscriber is compared to the one or more categories of the message that was created by the author. At 430, the author's message is sent to the subscriber when the one or more categories relate to the subject matter of the subscriber's content.

In another embodiment of the process 400, the author's message that is sent to the subscriber was created by the author during a particular time frame at 435. At 440, the time frame is specified by the subscriber. So, for example, a subscriber may indicate via this feature that he or she is interested only in recently created messages, or in messages created during a particular week or month. At 445, an author of the message is deleted prior to transmitting the author's message to the subscriber. At 450, the subscriber can subscribe to additional messages created by the author. And at 455, the processor filters messages such that more than one copy of a message is not sent to a subscriber.

FIG. 5A illustrates an example of a database that contains keywords. These keywords are searched for and identified in an electronic message, as indicated in FIG. 5B. After the identification of these keywords in the electronic message, a database of users is searched to determine the users to which the electronic message should be sent. An example of such a database is illustrated in FIG. 5C. As can be seen from FIG. 5C, User Nos. 2 and 4 will receive the electronic message because the keywords identified with their profile appear in the message of FIG. 5B.

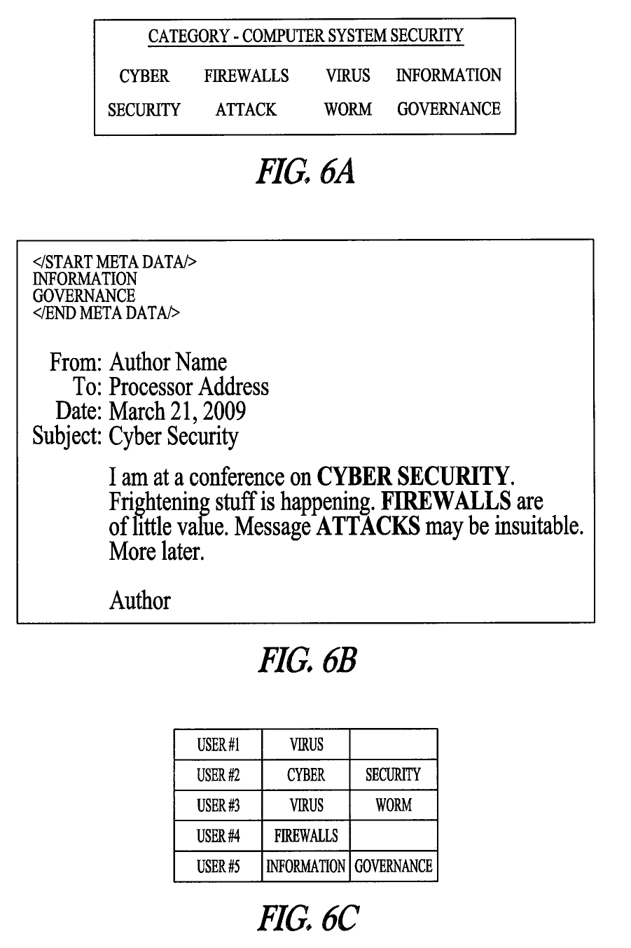

In another embodiment, an author of a message can, perhaps after creating a message, decide that additional “keywords” should be associated with this message. In this embodiment, the author can simply add a “keyword” that will be appended to the message as metadata. This metadata can then be used to identify messages that should be sent to users in a fashion similar to that illustrated in FIGS. 5A, 5B, and 5C. Specifically, FIG. 6A illustrates a database containing keywords. After an author creates a message, he or she may want to associate additional keywords with the message, that is, keywords in addition to those that appear in the text of the message. As shown in FIG. 6B, the author has added the keywords “information governance.” In the example of FIG. 6B, the keywords “information governance” are appended to the message as metadata, and is delineated by the tags “</startmetadata/>” and “</endmetadata/>”. This message will then be sent to any subscriber whose profile indicates an interest in messages relating to “information governance.” As illustrated in FIG. 6C, User No. 5 would receive this message because User No. 5 has “information governance” in his or her profile (in addition to User Nos. 2 and 4 because of the keywords in their profiles).

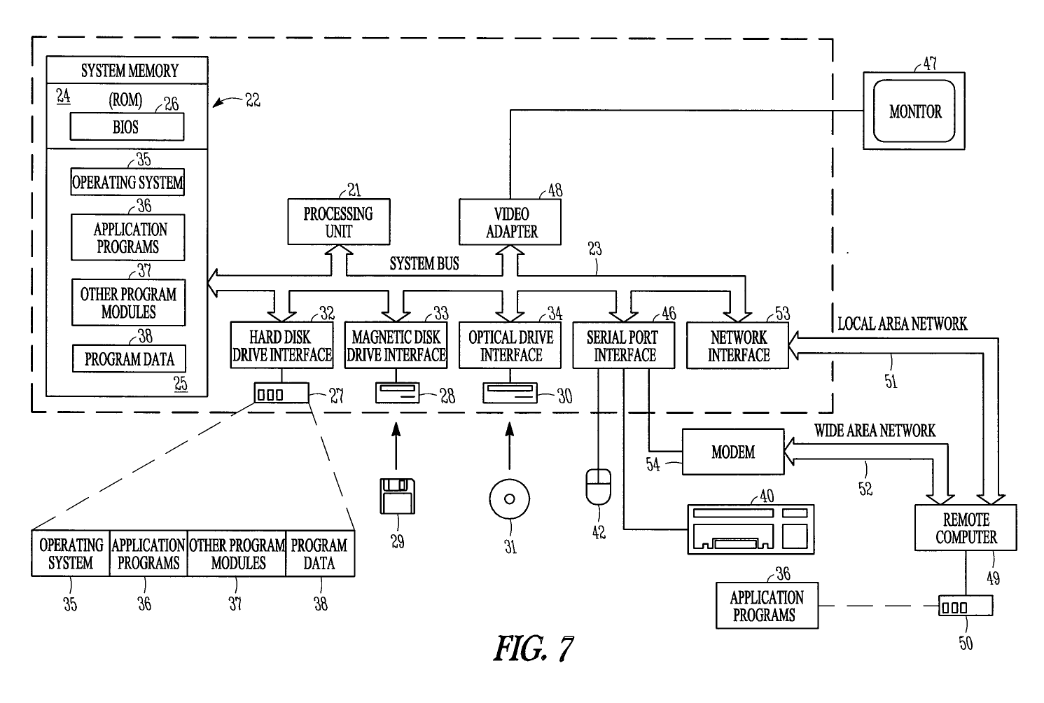

FIG. 7 is an overview diagram of a hardware and operating environment in conjunction with which embodiments of the invention may be practiced. The description of FIG. 7 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 7, a hardware and operating environment is provided that is applicable to any of the servers and/or remote clients shown in the other Figures.

As shown in FIG. 7, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 7 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are examples and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate example embodiment.

1. A computerized process comprising:
receiving at a processor an electronic message from an author;
analyzing the message;
assigning the message to one or more categories as a function of the analysis;
extracting from a database coupled to the processor one or more subscribers to the computerized process that are associated with the one or more categories, wherein the one or more subscribers are not identified in the message from the author; and
distributing the message to the one or more subscribers as a function of the one or more categories and not as a function of the author of the message.

2. The computerized process of claim 1, wherein the message comprises one or more of an email message, a twitter message, an instant message, a blog entry, a wiki entry, and a website page.

3. The computerized process of claim 1, wherein the analyzing the message comprises identifying a keyword in the message.

4. The computerized process of claim 3, wherein the assigning the message to one or more categories comprises using the keyword to identify a category.

5. The computerized process of claim 1, wherein the message is transmitted to a subscriber's URL, the subscriber's URL associated with one or more of a hand held device, a website, a blog, a wiki, and an email address.

6. The computerized process of claim 1, wherein the author of the message is a subscriber to the computerized process.

7. The computerized process of claim 1, wherein the author is not disclosed to the one or more subscribers to the computerized process.

8. The computerized process of claim 1, comprising configuring the processor to enable the one or more subscribers to the computerized process to subscribe to an additional message from the author.

9. The computerized process of claim 1, wherein the processor filters messages such that more than one copy of a message is not sent to a subscriber to the computerized process.

10. The computerized process of claim 1, wherein the processor comprises a first processor to receive the message from the author and a second processor to extract the one or more subscribers from the database.

11. A computerized process comprising:
receiving at a processor an electronic message from an author;
analyzing the message and creating a meta-tag as a function of that analysis;
comparing the meta-tag with a database of subscribers to the computerized process, the database coupled to the processor;
identifying in the database one or more subscribers that are associated with the meta-tag; and
transmitting the message to one or more subscribers as a function of the meta-tag and not as a function of the author of the message.

12. The computerized process of claim 11, wherein the processor prompts the author of the message to create the meta-tag.

13. The computerized process of claim 11, wherein the processor creates the meta-tag.

14. The computerized process of claim 11, wherein the author is not disclosed to the one or more subscribers.

15. The computerized process of claim 11, comprising configuring the processor to enable the one or more subscribers to subscribe to an additional message from the author.

16. The computerized process of claim 11, wherein the processor filters messages such that more than one copy of a message is not sent to a subscriber.

17. The computerized process of claim 11, wherein the processor comprises a first processor to receive the message from the author and a second processor coupled to the database.

18. A computerized process comprising:
receiving at a processor an electronic message from a person;
using a first database, determining that the person is affiliated with a group;
identifying in a second database coupled to the processor one or more subscribers that are linked to the group with which the person is affiliated; and
distributing the message to the one or more subscribers as a function of the group and not as a function of the person.

19. The computerized process of claim 18, wherein maintaining the first database comprises adding or deleting a person to the group.

20. The computerized process of claim 18, wherein the first database comprises subscribers that are members of a project.

21. The computerized process of claim 18, wherein the person in the first database is not disclosed to the one or more subscribers.

22. The computerized process of claim 18, comprising configuring the processor to enable the one or more subscribers to subscribe to an additional message from the person in the first database.

23. The computerized process of claim 18, wherein the processor filters messages such that more than one copy of a message is not sent to a subscriber.

24. A computerized process comprising:
receiving at a processor an electronic message from an author;
analyzing the message;
assigning the message to one or more categories as a function of the analysis;
using the processor to determine a subject matter of content that is associated with a subscriber to the computerized process;
comparing the subject matter of the content to the one or more categories of the message; and
sending the message to the subscriber when the one or more categories relate to the subject matter of the content.

25. The computerized process of claim 24, wherein the message that is sent to the subscriber was created during a particular time frame.

26. The computerized process of claim 25, wherein the time frame is specified by the subscriber.

27. The computerized process of claim 24, wherein the author of the message is removed from the message prior to transmitting the message to the subscriber.

28. The computerized process of claim 24, comprising enabling the subscriber to subscribe to an additional message or a subsequent message by the author.

29. The computerized process of claim 24, wherein the processor filters messages such that more than one copy of a message is not sent to a subscriber.

30. The computerized process of claim 24, wherein the content is an email message currently opened by the subscriber.

31. The computerized process of claim 24, wherein the processor comprises a first processor to receive the message from the author and a second processor to determine the subject matter of the content associated with the subscriber.
